(19) United States
(12) Patent Application Publication
(10) Pub. No.: US 2020/0250511 A1
(43) Pub. Date: Aug. 6, 2020

(54) ARTIST COMPREHENSIVE ABILITY EVALUATION AND CULTIVATION ASSISTANT SYSTEM BASED ON ARTIFICIAL INTELLIGENCE

(71) Applicant: Zhaoyang Hu, Greenwich, CT (US)

(72) Inventor: Zhaoyang Hu, Greenwich, CT (US)

(21) Appl. No.: 16/264,898

(22) Filed: Feb. 1, 2019

(51) Int. Cl. G06N 3/04; G06N 3/08; G06Q 30/02

(52) U.S. Cl. CPC G06N 3/0427; G06Q 30/0233; G06N 3/08

(57) ABSTRACT

An artist comprehensive ability evaluation and cultivation assistant system based on artificial intelligence comprises an artificial intelligence unit configured to: construct an artificial intelligence model according to an artificial neural network model and acquired data related to artist comprehensive ability evaluation and cultivation suggestions; and provide, according to the artificial intelligence model, a user having a demand for artist comprehensive ability evaluation and cultivation suggestions with one or more of: artist comprehensive ability reward point values, cultivation suggestions, prediction of situations and matching of information.

### FIELD OF THE INVENTION

The present invention relates to the field of artist evaluation and cultivation based on artificial intelligence, in particular to an artist comprehensive ability evaluation and cultivation assistant system based on artificial intelligence.

### BACKGROUND OF THE INVENTION

At present, it always has been a difficult problem to cultivate artists. Investors and brokerage firms often invest a lot of money, time and energy, but cannot guarantee the success rate of cultivating artists. On the other hand, many artists with talents, potentials and abilities do not know how to train themselves, and it is even more difficult to grasp the trend of social art development.

Artificial intelligence, abbreviated as AI in English, is a new technology science to research and develop theories, methods, technologies and application systems for simulating, extending and expanding human intelligence. Artificial Neural Network (ANN for short) is an operational model and a logic method to simulate human thinking realized by artificial intelligence on a computer. An artificial neural network model consists of a large number of nodes (or neurons) which are mutually connected. Each node represents a specific output function, called as activation function. A connection between every two nodes represents a weighted value, called as weight, for signals passing through the connection, which is equivalent to the memory of the artificial neural network. The output of the network varies according to the way of network connection, the weight and the activation function. The network itself is usually an approximation of a certain algorithm or function in nature, and it may also be an expression of a logic strategy.

A digital reward point (reward point for short) system is a kind of incentive that issuers use computer, Internet and other technologies to give the target population corresponding rewards or rights by enabling them to complete one or more specific tasks.

Digital reward points are a kind of right credentials for reward point gainers to receive rewards in the digital reward point system. Digital reward points may generally refer to all kinds of digital rights credentials such as reward points, discount vouchers, coupons, vouchers, group buying vouchers, lottery tickets, preemptive rights, preferential service rights and rights to settle down issued by all the issuers to encourage issued objects to complete certain behaviors in order to receive certain rewards or results. Its price relative to legal tender fluctuates.

Block chain technology is a totally new distributed infrastructure and computing way that uses block chain data structures to verify and store data, uses a distributed node consensus algorithm to generate and update data, uses methods of cryptography to ensure data transmission and access security, and uses intelligent contracts composed of automated script codes to program and operate data. Generally speaking, a block chain system consists of a data layer, a network layer, a consensus layer, an activation layer, a contract layer and an application layer, where the data layer packages the underlying data blocks and related basic data and basic algorithms such as data encryption and timestamp; the network layer includes a distributed networking mechanism, a data propagation mechanism, a data validation mechanism, and the like; the consensus layer mainly packages all kinds of consensus algorithms of network nodes; the activation layer integrates economic factors into the block chain technology system and mainly includes economic incentives issuing mechanism and distribution mechanism; the contract layer mainly packages various scripts, algorithms and intelligent contracts, which is the basis of the programmability of the block chain; and the application layer packages various application scenarios and cases of the block chain. In the model, chain block structures based on timestamp, consensus mechanisms of distributed nodes, economic incentives based on consensus computing power and flexible and programmable intelligent contracts are the most representative innovations of the block chain technology.

There are three problems with regard to the current cultivation of artists.

I. There is a lack of means for scientific evaluation of artist comprehensive ability at present.

At present, the evaluation of artists is mostly based on the experience of the investors and the brokerage firms, the ability to acquire data is very limited, it is difficult to have a comprehensive understanding about the artist's character, talent, family and ideology, and there is a lack of standardized evaluation means. Therefore, the evaluation of the ability of the artist is often biased. In addition, the artists themselves are unable to understand their own abilities in the situation of the market, resulting in a lack of direction for their development and efforts.

II. It is difficult to grasp the development trend of culture and art industries.

At present, due to the lack of massive data and effective analytical means, it is difficult for the investors and the brokerage firms to predict the trend of the development of the culture and art industries in future. Therefore, it is also very difficult to train artists in accordance with the characteristics of the artists and the development trend. The artists themselves have no ability to predict the trend to improve their self-cultivation.

III. There is a lack of scientific guidance for the training of artists.

In the process of cultivating artists, the artists themselves, the investors and the brokerage firms can only judge indexes such as training direction, characteristic discovery and customer preferences through personal experience, and there is a lack of comprehensive, data-based and scientifically analyzed suggestions and decision-making assistance. This has caused many problems in artist cultivation, such as positioning errors and direction errors, which directly leads to problems such as low success rate of artist cultivation results and low market recognition.

In addition, how to gain reward points, increase the intelligence of the evaluation system and strengthen the exchange and value establishment, are also the core of the present invention.

Therefore, a heretofore unaddressed need exists in the art to address the aforementioned deficiencies and inadequacies.

### SUMMARY OF THE INVENTION

The purpose of the present invention is to provide an artist comprehensive ability evaluation and cultivation assistant system based on artificial intelligence. It can realize prompting, prediction or matching based on artificial intelligence for at least partial functions of artist evaluation and cultivation.

In one aspect of the invention, an artist comprehensive ability evaluation and cultivation assistant system based on artificial intelligence comprises an artificial intelligence unit configured to: construct an artificial intelligence model according to an artificial neural network model and acquired data related to artist comprehensive ability evaluation and cultivation suggestions; and provide, according to the artificial intelligence model, a user having a demand for artist comprehensive ability evaluation and cultivation suggestions with one or more of: artist comprehensive ability reward point values, cultivation suggestions, prediction of situations and matching of information.

In one embodiment, the artificial intelligence unit comprises an information collection and sensing module, a computing module and an intelligent storage module, and the constructing the artificial intelligence model according to the artificial neural network model and acquired data related to artist comprehensive ability evaluation and cultivation suggestions comprises: using the information collection and sensing module to collect data; selecting core-related indexes of data related to evaluation and suggestions as input neuron nodes; calling the computing module to form a neural network model; and inputting collected historical data into the neural network model to train the artificial intelligence model according to a predetermined algorithm.

In one embodiment, the constructing the artificial intelligence model according to the artificial neural network model and acquired data related to artist comprehensive ability evaluation and cultivation suggestions further comprises: configuring the core-related indexes into related variables in a computer, wherein each of the related variables having a specific address and logic storage space in the intelligent storage module.

In one embodiment, the calling the computing module to form the neural network model comprises: adding weights for mutual influences among input variable nodes, hidden variable nodes and output variable nodes, to evaluate and quantify influences on other related variables when one or more of the related variables change.

In one embodiment, the inputting collected historical data into the neural network model to train the artificial intelligence model according to the predetermined algorithm comprises: (1) inputting historical data and sorting the related variables, the weights and result data according to a logic sequence, wherein the result data comprising at least one of: an artist comprehensive ability evaluation score node, a social literature and art preference development prediction node, an economic benefit analysis of artist cultivation node, an artist cultivation suggestion node, automatic rapid matching of fans group node, a risk evaluation and system operation efficiency and security prompt node; (2) operating, by the computer, to find and determine a model function relationship suitable for the related variables by using the result data as a function, the neural network, a regression mathematical model training method; determining, by the computer, an optimum function relationship by comparing fitting degrees between different function images and scatter diagrams, and storing the optimum function relationship in the intelligent storage unit; and (3) using, during training the artificial intelligence model, a back propagation network algorithm to return errors to each layer and node of the neural network while obtaining model output, wherein each node corrects a weight and then reacquires an input parameter to perform model verification till the errors decrease to a preset range; updating the data in corresponding storage spaces after obtaining effective weights and function relationships of nodes at each layer.

In one embodiment, the computing module further comprises a judgment and decision-making module, and when a decision needs to be made according to a reliable model after model verification, the judgment and decision-making module performs iterative verification on the optimum judgment of a system by adopting a simulated annealing algorithm, to guarantee that the decision-making is globally optimum.

In one embodiment, the computing module comprises at least one of a system learning and optimization module, an innovation and prediction module, an analysis, comparison and operation module and the judgment and decision-making module. The system learning and optimization module is configured to execute a self-learning process by using the back propagation algorithm. The innovation and prediction module is configured to perform innovative trying and development prediction on things by using an artificial intelligence algorithm based on current data and information. The analysis, comparison and operation module is configured to perform analysis, comparison and operation by adopting a proper method based on collected data after a target is clearly known, so that a decision-making and expression module outputs results. The judgment and decision-making module is configured to perform iterative verification on the optimum judgment of the system by adopting the simulated annealing algorithm, to guarantee that the decision-making is globally optimum.

In one embodiment, the artist comprehensive ability evaluation and cultivation assistant system further comprise a reward point management subsystem configured to execute the following steps: (1) receiving an operation instruction of a customer to reward points, the operation instruction containing an indicator, the indicator being used for indicting information of corresponding reward points stored in a network node device; searching reward point data matching a customer behavior according to the indicator; and (2) confirming an operation behavior of the customer to the reward points according to matched data stored in an organization, adjusting reward point quantity information of the customer after confirmation, and forming an operation.

In one embodiment, the reward point management subsystem is configured to further execute at least one of: (1) a reward point issuance and consumption operation, in which, when the customer consumes and evaluates an artist, the system uses a reward point system to give a score to the artist, and after evaluation is completed, the evaluation and cultivation assistant system instructs to increase corresponding reward points in a customer logic storage unit; and when the customer uses the reward points to exchange one or more of corresponding rights, services and real objects, the system instructs to decrease the corresponding reward points in the customer logic storage unit; (2) an artificial intelligence prompt operation, configured to manage a price of the reward points and prompt a customer about a price change trend of the reward points according to personal risk and benefit preference information; and (3) a reward point transfer operation, in which, when any reward point of an access customer changes, the evaluation and cultivation assistant system needs to confirm that a transferee of assets or reward points has an account of such reward points, and decreases reward points of a transferor, increases reward points of the transferee, and saves relevant records, by interacting information with a third party or a reward point transaction platform.

In one embodiment, the artist comprehensive ability evaluation and cultivation assistant system further comprise a block chain module, wherein the block chain module uses the evaluation and cultivation assistant system as a transmitting node and broadcasts a new data record block node of an organization applying a block chain service on the entire network; a receiving node decrypts the received data by using a consensus algorithm and performs recorded information verification to verify whether the information complies with a requirement on consensus within an integral block, and data records are brought into a block after verification; all receiving nodes on the entire network execute the consensus algorithm on blocks; and the blocks are formally brought into a block chain for storage after passing the consensus algorithm process.

In one embodiment, the core-related indexes of data related to evaluation and suggestions comprise one or more of: economic operation, scientific development, field of artists, and characteristics of artists.

In one embodiment, the regression mathematical model training method is one of a linear regression mathematical model training method and a nonlinear regression mathematical model training method.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 illustrates an architectural diagram of an evaluation and cultivation assistant system provided by the embodiments of the present invention.

FIG. 2 illustrates an M-P model schematic diagram of an artificial neural network used in the embodiments of the present invention.

FIG. 3 illustrates a schematic diagram of a formation process of a multilayer neural network of an artificial neural network used in the embodiments of the present invention.

FIG. 4 illustrates a schematic diagram of simulating a reality cause-effect superposition effect by an artificial neural network.

FIG. 5 illustrates a schematic diagram of a back propagation network optimization process.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, the phrase at least one of A, B, and C should be construed to mean a logical (A or B or C), using a non-exclusive logical OR. As used herein, the term “and/or” includes any and all combinations of one or more of the associated listed items.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The terms chip or computer chip, as used herein, generally refers to a hardware electronic component, and may refer to or include a small electronic circuit unit, also known as an integrated circuit (IC), or a combination of electronic circuits or ICs.

As used herein, the term microcontroller unit or its acronym MCU generally refers to a small computer on a single IC chip that can execute programs for controlling other devices or machines. A microcontroller unit contains one or more CPUs (processor cores) along with memory and programmable input/output (I/O) peripherals, and is usually designed for embedded applications.

The term interface, as used herein, generally refers to a communication tool or means at a point of interaction between components for performing wired or wireless data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The term code, as used herein, may include software, firmware, and/or microcode, and may refer to programs, routines, functions, classes, and/or objects. Some or all code from multiple modules may be executed using a single (shared) processor. In addition, some or all code from multiple modules may be stored by a single (shared) memory. Further, some or all code from a single module may be executed using a group of processors. Moreover, some or all code from a single module may be stored using a group of memories.

The apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

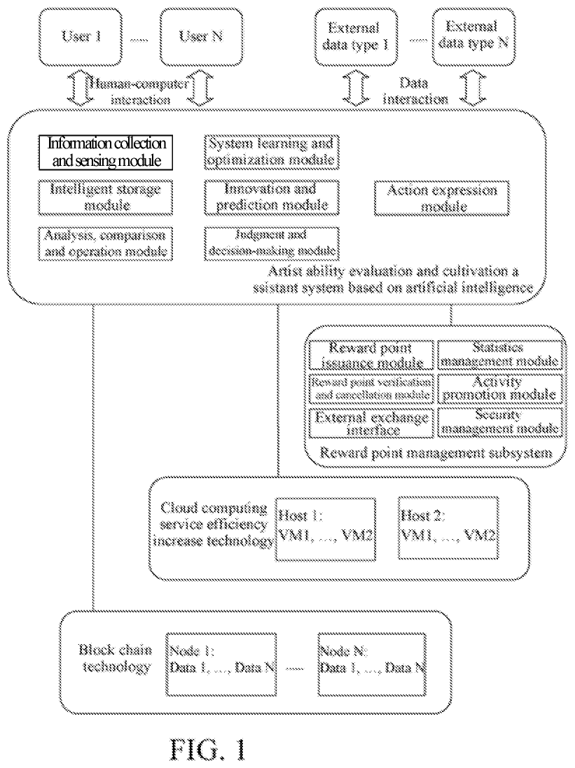

As illustrated in FIG. 1, the evaluation and cultivation assistant system mainly includes artificial intelligence modules such as an information collection and sensing module, an intelligent storage module, an analysis, comparison and operation module, a system learning and optimization module, an innovation and prediction module, a judgment and decision-making module and an action expression module, which can be integrated into an artificial intelligence unit. A core intelligence model is realized through an Artificial Neural Network (ANN) model. According to the specific type of data input into the artificial neural network, the evaluation and cultivation assistant system can complete, among artists and their intended investors, applications in the fields of political and economic analysis, public psychological analysis, cultural and entertainment market development prediction, media science and technology development trend, artist comprehensive ability evaluation score, social literature and art preference development prediction, economic benefit analysis of artist cultivation, artist cultivation suggestion, automatic rapid matching of fans groups, risk evaluation and system operation efficiency and security prompt.

The artificial neural network realizes intelligent functions mainly through the following steps:

S1: The evaluation and cultivation assistant system collects massive data actively or passively by using the information collection and sensing module. Data sources include data generated within the system, as well as data generated by the Internet, sensors and other data sources. In addition to passively receiving customer demand data and income data, the system automatically and intelligently collects relevant data by using technologies such as network crawler technology according to user demands or the efficiency increase demand of the system.

S2: The system selects core-related indexes in economic operation and transaction-related data, such as macroeconomic data, cultural and entertainment popular element preference data, media science and technology development situation data, public psychological survey data and social public opinions as input nodes (neurons), and configures the indexes into related variables in a computer. Similarly, the computer may also select variables such as artist appearance, artist special talent data, artist education background data and artist family background as the input nodes. Each variable has a specific address and logic storage space in the intelligent storage module. Increase of one neuron node variable will lead to increase of one logic storage unit.

S3: Programs and devices in the analysis, comparison and operation module, the system learning and optimization module, the innovation and prediction module and the judgment and decision-making module are called to form a neural network model, connection paths (i.e., weights) for mutual influences among input variable nodes, hidden variable nodes and output variable nodes are added, so as to evaluate and quantify influences on other variables when one or more variables change, to verify whether situations such as feedback effect and quantification effect are produced. The description of related paths (i.e., weights) and related variables have adjacent logic storage units, and each message contains information of corresponding variables, which facilitates the operation of the computer instruction by addressing weights and related variables.

S4: A result logic storage units needs to be designed in the intelligent storage module in the computer, and the unit sorts results according to a time sequence or a logic sequence, to facilitate the computer finding the results.

S5: The system inputs massive historical data actively or passively, and sorts the data including various variables of nodes, path (i.e., weights) and result data in the logic sequences such as time sequence and causal sequence. Result data mainly consists of data of political and economic situation analysis, public psychological analysis, cultural and entertainment market development prediction, artist comprehensive ability evaluation scores, social literature and art preference development prediction, economic benefit analysis of artist cultivation, artist cultivation suggestions, automatic rapid matching of fans groups, risk evaluation and system operation efficiency and security prompts. The data is ordered according to the logic storage space and according to the time sequence and logic sequence.

S6: After the data is successfully input, the computer automatically operates to find and determine a model function relationship suitable for various variables by using the result data as a function, and mainly using an artificial neural network and combining various mathematical model training methods such as linear regression and nonlinear regression. It should be noted that the function may be a multi-extremal function, that is, a certain thing does not necessarily have one best answer. The computer determines an optimum function relationship by comparing fitting degrees between different function images and scatter diagrams, and stores the optimum function relationship in the function logic unit.

S7: In a process of training the model, the computer uses a back propagation network algorithm to return errors to each layer and node of the neural network while model output is obtained, and each node corrects a weight and then reacquires an input parameter to perform model verification till the errors decrease to an acceptable range; and the computer updates the data in corresponding storage spaces after effective weight values and function relationships of nodes at each layer are obtained.

S8: When the system needs to make a decision according to a reliable model, the judgment and decision-making module performs iterative verification on the optimum judgment of the system by adopting a Simulated Annealing (SA) algorithm so as to guarantee that the decision is globally optimum and prevent the system from falling into a locally optimum situation.

S9: When the computer receives a new input layer independent variable value, the computer can predict an output layer node value (result) according to the calculated function relationship.

In addition, the evaluation and cultivation assistant system has a self-learning function of artificial intelligence, which is mainly executed by the system learning and optimization module by using the back propagation algorithm. When new target node (result) data is generated, the computer can automatically collect the result data, and recalculate the function relationship according to the change of variables, to improve the fitting degree of the model; and it can also automatically capture or manually add other variables for analysis, and calculate the correlation between variables and target nodes (results), if the variables have an influence on the target nodes (results), it is necessary to add such variables to recalculate the function model, and if there is no influence, it is not necessary to recalculate.

In the above-mentioned steps S1 to S9, the artificial neural network model is a main support model for the realization of the artificial intelligence function of the system. The specific framework of the model is mainly established by adopting a McCulloch-Pitts Model (MP model for short). The details are as follows:

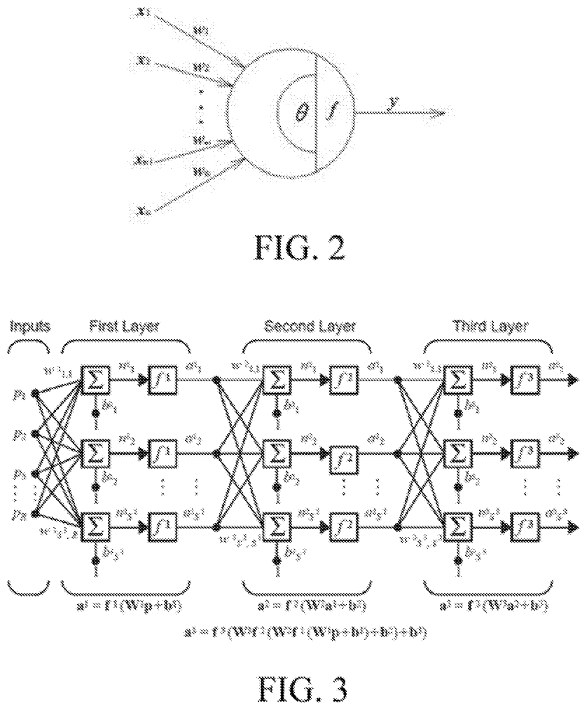

FIG. 2 illustrates a schematic diagram of an M-P model.

With reference to the schematic diagram of the M-P model, for a neuron j (not a variable, where j only serves as a marker of a certain neuron), it may receive multiple input signals at the same time, which are expressed as xᵢ. Since biological neurons have different synaptic properties and synaptic strength, the influences on neurons are different, and are expressed by weight value wᵢⱼ, its positive value and negative value simulate the excitation and inhibition of synapses in biological neurons, and its magnitude represents the different connection strengths of synapses. Because of the cumulative property, all input signals are cumulatively integrated, it is equivalent to the membrane potential in biological neurons, and its value is as follow:

$${\sum }_{i = 1}^{n} {w}_{i} {x}_{i}$$

The activation of neurons depends on a certain threshold level, that is, only when its total input exceeds the threshold, the neurons will be activated and emits pulses, and otherwise, the neurons will not generate output signals. The whole process can be expressed by the following function:

$$net = {\sum }_{i = 1}^{n} {w}_{i} {x}_{i} - θ$$

$$y = f ( net ) = f ( {\sum }_{i = 1}^{n} {w}_{i} {x}_{i} - θ )$$

Accordingly, it can be seen that:

each neuron is a multi-input and single-output information processing unit, and neuron inputs are divided into two types, i.e., excitatory input and inhibitory input;

neurons have the characteristics of spatial integration and threshold;

a fixed time lag exists between neuron input and output, which mainly depends on synaptic delay;

the time integration effect and the refractory period are ignored; and

the neurons themselves are time-invariant, that is, the synaptic delay and synaptic strength are constants.

In the above example, the transfer function can be a linear or nonlinear function. According to the need of fitting degree of the conclusion model function, the specific transfer function can be used to resolve the specific problems of neurons.

Usually, the neural network consists of a plurality of multi-layer neurons. A neuron has more than one input. Neurons with R inputs are as shown in FIG. 3. The inputs p₁, p₂, . . . , p_{R} respectively correspond to element w_{1,1}, w_{1,2}, . . . , w_{1,R} of weight matrix w.

The neuron has a bias value b, which accumulates with the weighted sum of all inputs to form a net input n, and its matrix expression is as follow:

n=w_{1,1}p₁+w_{1,2}p₂+ . . . w_{1,R}p_{R}+b.

The output is expressed as follow:

α=ƒ(Wp+b).

A schematic diagram of a network formed by the plurality of multilayer neurons is as shown in FIG. 3.

According to FIG. 3, the data involved in each business system not only can be used as inputs, but also can be used as outputs. Through massive data accumulation, by means of linear or non-linear regression and planning, the function of each neuron at each layer can be obtained. According to the fitting degree, the common function of each neuron will be selected from the following list of functions:

| Name | Input/output relationship |
|---|---|
| Hard limiting function | a = 0, n < 0; a = 1, n >= 0 |
| Symmetric hard limiting | a = −1, n < 0; a = 1, n >= 0 |
| function | |
| Linear function | a = n |
| Saturated linear function | a = 0, n < 0; a = n, 0 <= n <= 1; a = 1, |
| | n > 1 |
| Symmetric saturated linear | a = −1, n < −1; a = n, −1 <= n <= 1; |
| function | a = 1, n > 1 |
| Logarithmic-Sigmoid function | a = 1/(1 + e⁻ⁿ) |
| Hyperbolic tangent sigmoid | a = (eⁿ⁻ e⁻ⁿ)/(eⁿ⁺ e⁻ⁿ) |
| function | |
| Positive linear function | a = 0, n < 0; a = n, n >= 0 |
| Competitive function | a = 1, neuron with the largest n; a = 0, all |
| | other neurons |

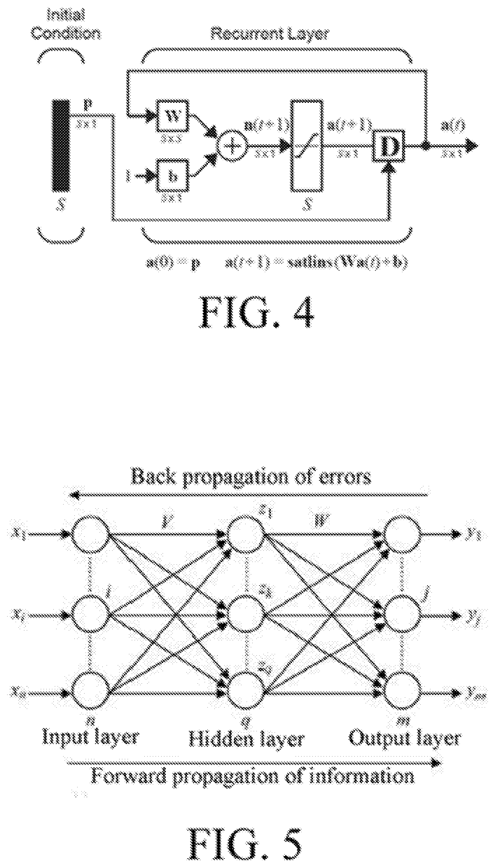

It should be noted that there is a causality superposition effect in the above-mentioned multilayer multi-neurons diagram, that is, the stage result of a thing will affect the cause of the next development of the thing. In view of this phenomenon, the neural network of the present invention has the characteristics of a recursive network, and can take part or all of the output as the input of a network of a certain layer, thus simulating the causality superposition effect in reality and obtaining more accurate output or neuron function model (as shown in FIG. 4).

In the process in which the neural network forms various models, there will be errors, resulting in final output deviation. In order to help output results and models to be more accurate, the evaluation and cultivation assistant system uses a Back Propagation network (i.e., BP network) algorithm to optimize the neural network system to ensure that the model training is more accurate and to reduce errors. The specific process is that the model learning process of each neuron consists of two processes, i.e., forward propagation of signals and back propagation of errors. During forward propagation, input samples are introduced from the input layer, are processed by hidden layers one by one, and then are transmitted to the output layer. If the actual output of the output layer does not match the expected output (teacher signal), the process proceeds to the back propagation stage of the error. Error back propagation is a process in which output errors are propagated back to the input layer from hidden layers layer by layer in a certain way, and the errors are allocated to all units in each layer, so as to obtain the error signal of each unit, which is the basis for correcting the weight value of each unit. The weight value adjustment process of each layer in signal forward propagation and error back propagation is carried out repeatedly. The process of continuous weight value adjustment is also a learning and training process of the network. This process continues until the network output error is reduced to an acceptable level, or until a predetermined number of learning times are carried out (as shown in FIG. 5).

In addition, in the aspect of decision-making of the optimum selection, on the basis of the artificial neural network, the evaluation and cultivation assistant system applies simulated annealing and an improved algorithm thereof to help the system be efficiently separated from a local extremum and quickly find a globally optimum decision.

Assuming that the neuron model function relationship of the evaluation and cultivation assistant system has been accurately trained and a minimum value (such as the lowest price) needs to be found, the generation and acceptance of the new solution to the simulated annealing and the improved algorithm thereof can be divided into the following four steps:

The first step is to generate a new solution in a solution space from the current solution by a function already in the neural network, and this solution represents the possible decision of the neural network. In order to facilitate the subsequent calculation and acceptance and to reduce the time consumed by the algorithm, the method that can generate a new solution by simple transformation of the current new solution, such as replacement and interchange of all or part of the elements of the new solution, is usually selected. It needs to be noted that the transformation method of generating the new solution determines the neighborhood structure of the current new solution, and thus it has a certain influence on the selection of cooling schedule.

The second step is to calculate the objective function difference corresponding to the new solution. Because the objective function difference is only caused by the transformation part, the calculation of the objective function difference is done by incremental computation.

The third step is to judge whether the new solution is accepted or not. The basis of judgment is an acceptance criterion. The most commonly used acceptance criterion is Metropolis criterion: if ΔT<0, S′ is accepted as the new current solution S, otherwise, S′ is accepted as the new current solution S with a probability of exp(−ΔT/T).

The fourth step is to replace the current solution with the new solution when the new solution is determined to be accepted. This can be realized by only the transformation part of the current solution corresponding to the generation of the new solution, and correcting the value of the objective function. At this moment, the current solution realizes one iteration. On this basis, the next round of test can be started. When the new solution is determined to be abandoned, the next round of test will be carried out on the basis of the original current solution.

Simulated annealing and the improved algorithm thereof are independent of the initial value, and the solution obtained by the algorithm is independent of the initial solution state S (which is the starting point of the iteration of the algorithm); simulated annealing and the improved algorithm thereof have asymptotic convergence, and have been proved theoretically to be a global optimization algorithm convergent to the globally optimum solution with probability of 1; and simulated annealing and the improved algorithm thereof have parallelism.

Through the above-mentioned method, the global limit value of the neural network can be efficiently found under the model with determined function relationship, so as to make the optimum decision, and avoid falling into the trap of partially optimum decision.

With the assistance of the above-mentioned functions, according to the specific type of input data, such as macro-political and economic data, public income data, media science and technology development data, public cultural tendency data, cultural and entertainment market dynamic data, cultural industry ecological data, artist characteristics data, artist family data, artist character data, artist image data and artist education background data, the evaluation and cultivation assistant system can be used to realize functions such as political and economic situation analysis, public psychological analysis, cultural and entertainment market development prediction, artist comprehensive ability evaluation scores, social literature and art preference development prediction, economic benefit analysis of artist cultivation, artist cultivation suggestion, automatic rapid matching of fans groups, risk evaluation, and the system operation efficiency and security prompt. The following is a description of multiple functions that can be realized by the evaluation and cultivation assistant system. It should be understood that different functions require input of corresponding data when the artificial intelligence models are constructed. In this embodiment, only specific result data is introduced, and input data for deep learning can be input according to the results data when the models are constructed.

Investor or brokerage firm users can use their preferences to describe their demands to the evaluation and cultivation assistant system by various means such as voices, texts and form selection. The system will realize demand intelligent selection and intelligent pushing. At the same time, the users can also shield information that they do not want to obtain at present, so as to avoid time waste and harassment.

The system can prompt artist users the corresponding fans, audiences, brokers, investor customer demand situations, as well as the overall demand concerning of the market, and provide evaluation and self-cultivation suggestions for the artists. In addition, the system prompts the artists to perform potential matching between their own styles and characteristics with the income, preferences and ages of the audience groups, so as to realize accurate pushing for promotion.

The system has an artist self-recommendation market, which uses the network as a tool and realizes transactions in the mode of e-commerce. Artists, brokers, investors and other relevant organizations perform self-recommendation and recruitment of various artists on the corresponding electronic platform through computer networks, including operations such as artist talent show, artist introduction, pricing, cooperation, advertising invitation, selection of film and television roles, online contract signing, payment and settlement. In addition to cash, the evaluation and cultivation assistant system also supports related functions such as pricing, payment and settlement for artist cultivation by using reward points, so as to facilitate the users to use reward points as a means of payment to complete payment.

According to the demands and the description of investors and artists for the characteristics of the artists, the system can intelligently push artist information and help both parties cooperate quickly.

The system can perform comprehensive analysis according to related data such as market supply and demand situations, customer psychological survey, economic factors, scientific and technological factors, political factors, including resident income level, total economic development, exchange rate, interest rate, inflation rate, media science and technology situations, audience population characteristics, cultural and entertainment industry development situations, popular elements, popular trends, characteristics of brokers, system operation situations, population, urbanization rate, artist attention degree, number of comments, exposure rate, historical transaction price of artist brokerage and the like, and prompt the fluctuation trends of artist talent values to the artists, the brokers, the investors and so on. It can suggest the brokers and the investors to invest and cultivate certain types of artists, and can also suggest artist self-cultivation directions.

The system can intelligently prompt the investors, the brokers and other artist training organizations or individuals about more prominent artist situations according to the data input by users; can also prompt such organizations or individuals to select artists according to popular elements and public psychology; and can know their preferences and recommend suitable artists according to investment habits of these people.

The system can provide an intelligent consultation function. When the artists recommend themselves, they can get information about similar artists, including talents, appearance, characteristics, specialties, positioning, audience feedback and so on. It can help the artists to make full research on their own positioning and cultivation, and avoid blind cultivation.

The evaluation and cultivation assistant system has an artificial intelligence upgrade interface. For other intelligent functions not listed above, automatic upgrading can be performed according to demands, and it can also learn from third-party open source code, or add third-party devices to assist the evaluation and cultivation assistant system to be upgraded and grow.

Each module can be understood as a program module or a module combining software and hardware. With reference to the execution steps and processes of each module or unit, a person skilled in the field can realize various functions by programming and adopting corresponding software and hardware.

On the other hand, the evaluation and cultivation assistant system also supports an issuance and reclaim system of reward points, and on this basis, forms the following corresponding functions:

To achieve the above-mentioned functions, the evaluation and cultivation assistant system needs to have the following modules: a reward point issuance module, a reward point verification and cancellation module, an external exchange interface, a statistics management module, an activity promotion module, and a security management module.

After the evaluation and cultivation assistant system receives the operation instructions for issuing or reclaiming reward points from customers using services, where the information contains an indicator which is used for indicating information corresponding to the digital assets stored in the network node device. The evaluation and cultivation assistant system controls the cloud server to receive the session instruction information from the network node to find reward point data matching the customer behaviors.

The evaluation and cultivation assistant system confirms the customer's operation behavior to the digital assets or reward points according to the matched data stored in the organization, adjusts the customer's digital asset or reward point quantity information after confirmation, and forms an operation.

The evaluation and cultivation assistant system has a third-party payment module, which can be used for, when a customer uses reward points to pay, firstly paying the reward points to the evaluation and cultivation assistant system, and the evaluation and cultivation assistant system notifies the seller to perform the contract; and the customer receives the artist brokerage right and confirms the transaction after investigating the artist, or if no contract canceling operation is performed within a certain period of time, the system will regard that the transaction has done and instruct to decrease the corresponding digital assets or reward points in the logic storage unit of the buyer customer, and increase the reward points in the logic storage unit of the buyer.

A payment account management module is used for the following: if the digital assets of the customer accessing to the evaluation and cultivation assistant system are assigned, transferred, renamed and given as a gift, the evaluation and cultivation assistant system should firstly confirm that a transferee of assets or reward points has an account of such assets or reward points, and perform information interaction with a third-party digital asset or reward point transaction platform through the external exchange interface, decrease the transferred digital assets or reward points of a transferor, increases the digital assets or reward points of the transferee, the information record module is used for saving relevant records, and information transaction security can be managed by the security management module.

In addition, the evaluation and cultivation assistant system can provide block chain application services for reward points and data of the evaluation and cultivation assistant system according to the demands of individual organizations. The work flow of the block chain is mainly executed by the block chain module according to the following steps: the software and hardware system of the evaluation and cultivation assistant system is used as a transmitting node to broadcast a new data record block chain node (such as number of fans of a certain artist, attention degree, total reward points and remuneration record) of an organization applying the block chain service on the entire network, where the data is strictly encrypted on the whole; a receiving node decrypts the received data by using a consensus algorithm and performs recorded information verification to verify whether the information complies with a requirement on consensus within an integral block, and data records are brought into a block after verification passes; all receiving nodes on the entire network execute the consensus algorithm (proof of workload, proof of rights and interests, etc.) to a block, where the workload or rights and interests are paid by means of reward points; and the block is formally brought into a block chain for storage after passing the consensus algorithm process, all network nodes express to accept the block, the method of expressing acceptance is to regard the random hash value of the block as the latest block hash value, and the manufacture of the new blocks will be extended on the basis of the block chain. In this way, the data records of all organizations applying the block chain technology in the evaluation and cultivation assistant system are disclosed and unalterable, and are recorded publicly by a plurality of nodes in the block, such that the core data and records of the organizations are open and transparent so as to increase the credit of the organizations.

The evaluation and cultivation assistant system will provide a unified public block chain technology for all organizations applying the system, including service architecture such as public block chain, alliance block chain and private block chain. Any organization requiring block chain service can apply the block chain technology service provided by the service system. The organizations that need to apply the block chain need to perform related preparation work such as technology adjustment and incentive policy confirmation according to the requirements of the evaluation and cultivation assistant system, such that they can provide accessibility of their own data in service and transaction to the block chain system, so as to achieve open, transparent and unalterable data accounts.

On the other hand, with reference of the above-mentioned method, in order to help the users of the evaluation and cultivation assistant system to improve efficiency, the present invention also provides an apparatus, which integrates the functions of the evaluation and cultivation assistant system, and has various mainstream hardware interfaces such as USB and SD cards, so as to assist the evaluation and cultivation assistant system to upgrade, learn and develop.

In the following embodiments, the evaluation and cultivation assistant system is applied.

### Embodiment 1

Customer A is a registered user of the evaluation and cultivation assistant system and an artist broker, whose main purpose is to use the evaluation and cultivation assistant system to find suitable artists.

The customer opens the evaluation and cultivation assistant system, and the evaluation and cultivation assistant system asks: “Hello, what can I do for you?”

The customer answers with voice: “I want to find suitable artists to sign up for cooperation.”

After a system sensor collects the voice of the customer, it performs information sampling, compares the voice with a voice and character recognition library, converts the voice into a text, and inputs the text into the evaluation and cultivation assistant system.

The evaluation and cultivation assistant system uses the neural network system to recognize Chinese sentences after receiving the input information.

After that, the system takes each word in the sentences as an input, calls a word and part-of-speech corresponding library to recognize the part of speech, and comprehensively grabs the core words of the corresponding sentence according to the subject, predicate, object, attribute, adverbial, complement and various combination phrases.

The system performs matching by using the core words or phases of “I”, “want to find”, “suitable”, “artists” and “cooperation” as the core conditions respectively. According to a corresponding phrase table, the system identifies pronoun “I” as the customer himself, the subject, i.e., the subject of the action; identifies “want to find” as the verb and predicate, which represents for a searching action; identifies the quantifier “suitable” as an adjective, which represents “suitable for customer A”; identifies the noun “artist” as an object, which represents the implementation object of the predicate; and identifies “sign up for cooperation” as a complement to complementarily describe the predicate and object.

The artificial neural network inputs the above-mentioned words as variables into the neurons of different layers, and according to the model stored in the neurons, the following output results are formed:

Each question is formed as a blank filling or multiple choice question, which is answered selectively by the customer A. The results are as follows:

The results of the answers of customer A are as follows:

Age range of artists? Answer: 19-23 years old.

Artist gender? Answer: female.

Education background? Answer: professional associate degree or above.

Height: 165-173 cm.

Weight: 52 kg or below.

What talents are required? Answer: acting, dancing.

Marital status: single, in a relationship, married.

What popular elements are needed? Answer: HIP-HOP.

What family background is required? A: normal family, not single parent.

What is the price range of target signing? Answer: 1-2 million RMB per year.

Is there any requirement on native place? Answer: no.

What is the range of current number of fans? Answer: 100 thousand −1 million.

What are the most popular media? Answer: Internet, TV and radio.

Professional training experience: dance, model.

Do you accept the transfer of other brokers? Answer: Yes.

How many years do you want to train? Answer: 2 years.

The system takes the answers as input variables of the neural network. After the model performs operation on these variables, the output conditions are formed, and these conditions are matched with the control modules in the computer to carry out corresponding operations. The computer searches qualified artists in the evaluation and cultivation assistant system, selects the qualified artists as the outputs according to the excitation and inhibition factors input by the neurons, and orders the qualified artists according to the matching degree. At the same time, a variety of classification and ordering pages are displayed according to the artist's characteristics. The user is prompted to select artists.

If the system does not select a suitable artist according to the inhibition factors, it will output a prompt that no artist has been found, and inform the user which inhibitory input leads to the output that there is no suitable artist, and ask customer A whether this condition can be changed, as follows:

After searching, the evaluation and cultivation assistant system does not find an artist who meets the above-mentioned requirements and outputs the following result:

“Sorry, there is no artist that you want. Because no artist who has training experience in dancing is found according to your conditions. Do you accept any other training experience?”

Customer A selects: “accept any other training experience”.

After the system adjusts the inputs, the system performs searching again and the output results are as follows:

| | Remuneration | | | | | | | | |
|---|---|---|---|---|---|---|---|---|---|
| | (10 thousand | | | Living | | Education | Number | | Marital |
| Name | RMB) | Height | Age | place | Media | background | of fans | Recommended by | status |
| XXX | 110 | 168 | 20 | Zhejiang, | Internet | Associate | 120,000 | Self-recommendation | Single |
| | | | | China | | degree | | | |
| YYY | 180 | 170 | 19 | USA | TV | Bachelor | 500,000 | Broker | Single |
| | | | | | | degree | | | |
| ZZZ | 120 | 166 | 21 | Beijing, | TV | Bachelor | 900,000 | Broker | Single |
| | | | | China | | degree | | | |
| QQQ | 190 | 169 | 23 | UK | Radio | Associate | 300,000 | Self-recommendation | Married |
| | | | | | | degree | | | |
| PPP | 102 | 168 | 21 | Shanghai, | Internet | Bachelor | 700,000 | Broker | In a |
| | | | | China | | degree | | | relationship |

Each artist in the above-mentioned table is the most suitable one obtained by the system by automatically comparing similar artists. At the same time, the system can order according to each field of the above-mentioned table to help customer A complete the selection. In addition, the system also provides an all-artists screening function. If the user needs to expand the search, it can also be realized.

Customer A selects to train ZZZ, and needs to evaluate ZZZ comprehensively before determining to cultivate. According to the requirement of customer A, the system automatically grabs information about ZZZ from the Internet such as audience rating, video, comment and news, and combines environmental information such as macro-political and economic data, public income data, media science and technology development data, public cultural tendency data, cultural and entertainment market dynamic data, and cultural industry ecological data, and inputs into the neural network according to personal file data input by the artist himself or herself, including data related to artist ability evaluation such as artist characteristic data, artist family data, artist character data, artist image data and artist education background data.

In the neural network, firstly, the authenticity of information is analyzed to remove or reduce the weight of unreliable information, and the following conclusions are formed:

ZZZ evaluation report and cultivation suggestions

| | Remuneration | | | | | | | | |
|---|---|---|---|---|---|---|---|---|---|
| | (10 thousand | | | Living | | Education | Number | | Marital |
| Name | RMB) | Height | Age | place | Media | background | of fans | Recommended by | status |
| XXX | 110 | 168 | 20 | Zhejiang | Internet | Associate degree | 120,000 | Self-recommendation | Single |

| | |
|---|---|
| 1. | Image and temperament |
| | Appearance score: 89%, evaluated according to the Internet, sample size: 2043 |
| | Clothing quality score: 67%, evaluated by audience, fans and professionals, sample size: 183 |
| | Popularity: 19%, according to Internet survey, sample size: 3231 |
| | Character characteristics: outgoing, enthusiastic but timid, according to self-evaluation, friends |
| | and fans' evaluation, sample size: 201 |
| | Public popularity: 73%, audience evaluation sample size: 1032, weight: 61%, expert sample size: |
| | 5, evaluation weight: 39% |
| | Appearance defect: slightly wide cheek, single eyelid |
| 2. | Talent and Specialty |
| | Talent and skills: HIP-HOP + dance, talent professional score: 91%, evaluated according to the |
| | Internet, sample size 392 |
| | Art inspiration: 65%, according to artist test questionnaire |
| | Education Index: 60%, according to market comprehensive evaluation |
| | Birth index: 68%, determined according to family culture, background, income, schools, etc. |
| | Voice feature: 86%, audience evaluation sample size: 876, weight: 55%; expert sample size: 6, |
| | evaluation weight: 45% |
| | Instrument score: guitar: 54%, expert rating, sample size: 5 |
| | Versatile expertise: art 84%, won 4 awards at home and abroad |
| | Past achievement: 27%, obtained according to weight of performance participated, Internet live |
| | webcast fans: 120,000, no solo concert; low audience rating of participated Internet TV shows |
| 3. | Potential |
| | Selling points (characteristics): facial naughty expression: 76%, evaluated according to Internet, |
| | sample size: 1346, experts: 3, weight: 50% respectively |
| | Gossip: 65%, evaluated by audience, fans and professionals, sample size: 3659 |
| | Story: versatile and inspiring 70%, Internet, sample size: 294, experts: 4, weight: 50% |
| | respectively |
| | Social skills: 88%, evaluated by family members, teachers and friends, sample size: 15 |
| 4 | Negative factors |
| | Crime: 20%, evaluated according to a crime prediction model of a large number of samples such |
| | as personality, psychology and family background |
| | Moral scandals: 21%, evaluated according to a crime prediction model of a large number of |
| | samples such as personality, psychology and family background |
| | Sudden illness: 18%, obtained according to a prediction model of sample data such as genetic |
| | data, hobbies, and work-rest schedule |
| | Career change or withdrawal: 32%, obtained according to an evaluation and predication model |
| | of personality, psychology and historical experience |
| 5 | Comprehensive evaluation |
| | Score: 74%, recommended to cultivate |
| | Scoring basis: HIP-HOP has good prospects and the market has a relatively large space for |
| | growth; the artist herself has great potential, medium-high level of comprehension, versatile |
| | talent of art, and stories have room to dig, currently there is a lack of marketing awareness, she |
| | needs package and marketing; the overall negative factors of the artist are low, the health |
| | condition is good, and the risk of interruption of performance is low in the short term. |
| 6 | Cultivation suggestions |
| | Cultivation analysis: at present, the per capita income is high, the economy is good, but the |
| | pressure of work is high, people need to look for music such as HIP-HOP to learn or watch so as |
| | to release the pressure, and thus it is predicted that the market space of HIP-HOP will increase |
| | by about 300% in the next five years; the artist's own image, story and art talent have a hype |
| | value; virtual new media such as AR/VR have developed rapidly. |
| | Suggestion: strengthen the cultivation in HIP-HOP as the HIP-HOP market space is better. |
| | Suggestion: package artist's inspiring stories and art talent in detail, and comprehensively |
| | propagate over television, Internet and other media. |
| | Suggestion: promote the artist by applying new science and technology media, in order to grow |
| | together and get twice the result with half the effort. |
| | Proposed contract price: 1 million/year Recommended cultivation time: 1-2 years Future |
| | return: 400%-600% |

According to the policy, after completing evaluation, the system will give TTT100 reward points issued by the system to customer A as a present.

After Customer A shares or promotes the system, he will get reward points issued by the system every time a customer clicks or logs in. The rules are 1 TTT reward point for each click and 2 reward points for each registration. At each time when the reward points are issued, the system will instruct the logic storage unit of the customer to increase the reward points in the intelligent storage unit.

The system has a reward point exchange mall, and reward points can be exchanged for various rights and interests, goods or services.

10000 reward points for one free evaluation

20000 reward points for 1 day of system advertising space

50000 reward points for 10 times of artist live show (charges)

After exchange of each article, the system will instruct the logic storage unit of the customer to decrease the reward points in the intelligent storage unit.

In addition, exchange of reward points among customers is supported. According to an exchange signal provided by the customers on the third party exchange platform, the reward points of the customers can be increased or decreased.

Cloud technology efficiency enhancement service predicts comprehensive indexes such as future system visits, purchases and exchanges through the artificial intelligence prediction model of the system, and if the conclusion shows that the prediction evaluation indexes of a certain merchant or individual have exceeded the software and hardware endurance threshold of the current service system, the management module sends resource allocation enhancement information to the cloud computing efficiency enhancement module. According to the traffic demand predicted by the management module, the cloud computing efficiency enhancement module retrieves the hardware system resources, and finds that the current data traffic of a merchant A is stable and the hardware resources are idle. The efficiency enhancement module submits an application to the management module, the operation module and the judgment module for decreasing the hardware resources allocated to merchant A, and clarifies the resource demand. After prediction and judgment, the operation module and the judgment module confirm that the logic resource allocation of the artist ZZZ will not grow too fast in the future to exceed the threshold, and send the conclusion to the management module. After confirmation, the management module sends an adjustment permission to the efficiency enhancement module, the efficiency enhancement module will increase the service resources allocated to other artists according to the application, and decrease the service resources allocated to the artist ZZZ.

The process that the intelligent efficiency enhancement system selects and allocates computer resources in a resource pool is as follow:

The resource pool mainly includes a virtual computing resource pool, a virtual network resource pool and a virtual storage resource pool, where the virtual computing resource pool is formed by one or more physical hosts (2l-2n) through the virtualization technology, and mainly contains resources such as CPU and memory; the virtual network resource pool is formed by various network devices such as routers, switches, firewalls and Load Balance (LB) devices through the virtualization technology, and mainly contains resources such as network bandwidth; and the storage resource pool is formed by various storage devices through the virtualization technology, and mainly contains resources such as storage capacity and storage I/O, and the storage devices can be local storage, IPSAN, Network Attached Storage (NAS), object storage and so on. The resource pool includes a plurality of hosts, and the hosts carry a plurality of virtual machines (VMs) and allocate virtual resources for the VMs. The hosts that can migrate VMs with each other form a migration domain. VMs on a host share computing resources (CPU or memory, etc.), storage resources (local storage or storage I/O) and network resources (network I/O). When a HOST cannot satisfy the resources needed by the VMs carried thereon, it will cause the decline of the QoS of the VMs, and VM migration is needed to ensure the QoS of the VMs.

If the resources are saturated, an alarm will be given to prompt to perform human intervention.

### Embodiment 2

XXX is an artist, and hopes to promote through live webcast.

XXX registers in the evaluation and cultivation assistant system and needs the evaluation and cultivation assistant system to:

1. Build her own live webcast model.

2. Predict the number of fans according to different webcast charge pricing strategies.

The system asks as follows:

“Hello, what can I do for you?”

XXX: “I am an artist. I want to perform live webcast. I need to predict the number of fans for the live webcast and make a live webcast charging strategy.”

Similar to the Embodiment 1, the system uses the sensor to sample the voice and regards the result as an input of the neural network. The function of the neural network is to recognize the Chinese voice sampling result against the word comparison library, which belongs to the analysis and comparison module. After the identification is completed, the system translates the voice into words as an input to the next layer of neurons. The model in the next layer of neurons is a grammar comparison library, which can decompose the sentence according to the grammar. The decomposed words and phrases serve as inputs to the next layer of neurons. The model in the next layer of neurons is semantic recognition, which establishes connections between the decomposed words, vocabulary and phrases and control instructions of the computer and data fields.

After recognizing the voice of XXX, the evaluation and cultivation assistant system uses a comparison table model in the neural network to form the following statement, and uses a display module to ask XXX:

“OK, I understand. What are the characteristics of your live webcast, including:

Live webcast charge range?

Content?

People that you face to?

Duration?

Prop background?”

XXX answers:

“Price range? Answer: 3-9 RMB

Content? Answer: Russian Dance

People that you face to? Answer: teenagers

Duration each time? Answer: 60 min

Prop background? Answer: outdoor scenario”

According to the answers of XXX, the system inputs the answer texts into the analysis and comparison model of the neural network. The system searches the entire Internet network and finds three similar live webcast programs. The system outputs:

“Hello, we have found 3 similar live webcast programs for you, namely HHH, JJJ and LLL. Please select one as our reference object.”

XXX selects JJJ as the reference object.

The sales data of JJJ searched by the system is as follows:

| | | | | | | | | | | |
|---|---|---|---|---|---|---|---|---|---|---|
| Online live | 100 | 75 | 80 | 70 | 50 | 65 | 90 | 100 | 110 | 60 |
| webcast fans | | | | | | | | | | |
| number (10 | | | | | | | | | | |
| thousand) | | | | | | | | | | |
| Cultural and | 1000 | 600 | 1200 | 500 | 300 | 400 | 1300 | 1100 | 1300 | 300 |
| entertainment | | | | | | | | | | |
| expense level | | | | | | | | | | |
| (RMB) | | | | | | | | | | |
| Live webcast | 5 | 7 | 6 | 6 | 8 | 7 | 5 | 4 | 3 | 9 |
| charged per | | | | | | | | | | |
| person (RMB) | | | | | | | | | | |

The evaluation and cultivation assistant system applies a neural network mode to obtain models in the neural networks.

According to the above-mentioned data, a neuron model established by the neural network in combination with the use of multiple nonlinear regression can be obtained, and the regression model is:

y=110.5313+0.1464x₁−26.5709x₂−0.0001x₁²+1.84754x₂²

where X₁ is the related expense, X₂ is the live webcast charge price, and y is the number of fans.

After obtaining the model, the system automatically uses the back propagation network algorithm to check the fitting degree of the model and adjust it to reduce errors.

P groups of samples (X₁, T₁; X₂, T₂; . . . Xₚ, Tₚ) are given. Here X₁ is an nᵢ-dimensional input vector and Tᵢ is nₒ-dimensional expected output vector, i=1, 2, . . . , P. Assuming that the vectors y and o respectively represent the output vectors of the output layer and the hidden layer of the network, the training process can include the following steps:

1) selecting η>0, Eₘₐₓ as the maximum allowable error, and initializing the weight coefficient W^{l}, θₗ,l=1, 2, . . . , L into a certain small random weight matrix p←1, E←0;

2) starting training oₚ⁽⁰⁾←Xₚ,T←Tₚ, and according to

$${o}_{pj}^{( r + 1 )} = {Γ}_{r + 1} ( {\sum }_{l = 1}^{{n}_{r}} {ω}_{jl}^{r + 1} {o}_{p l}^{( r )} + {θ}_{j}^{r + 1} ) r = 0 , 1 , 2 , … , L - 1$$

$${y}_{pj} = {Γ}_{L} ( N e {t}_{pj}^{L} ) = {Γ}_{L} ( {\sum }_{i = 1}^{{n}_{L - 1}} {ω}_{ji}^{L} {o}_{pi}^{( L - 1 )} + {θ}_{j}^{L} ) j = 1 , 2 , … , {n}_{o}$$

calculating the excitation output of neurons in each hidden layer and the excitation output of neurons in each output layer;

3) calculating an error E←[(tₖ−yₖ)²/2]+E,k=1, 2, . . . , n₀

4) calculating a generalized error

$$\begin{matrix}r = L\end{matrix}$$

$$\begin{matrix}{δ}_{pj}^{L} = - \frac{\partial {e}_{p}}{\partial N e {t}_{pj}^{L}} = - \frac{\partial {E}_{p}}{\partial {y}_{pj}} \frac{\partial {y}_{pj}}{\partial {Net}_{pj}^{L}} = ( {t}_{pj} - {y}_{pj} ) {Γ}_{L}^{′} ( Ne {t}_{pj}^{L} )\end{matrix}$$

$$\begin{matrix}r \neq L\end{matrix} \begin{matrix}{δ}_{pj}^{r} = - \frac{\partial {e}_{p}}{\partial N e {t}_{pj}^{r}} = - \frac{\partial {E}_{p}}{\partial {o}_{pj}^{r}} \frac{\partial {o}_{pj}^{r}}{\partial {Net}_{pj}^{r}} = ( {\sum }_{k} ( \frac{\partial {E}_{p}}{\partial N e {t}_{p k}^{r + 1}} \frac{\partial Ne {t}_{p k}^{r + 1}}{\partial {o}_{pj}^{r}} ) {Γ}_{r}^{′} ( Ne {t}_{pj}^{r} ) )\end{matrix}$$

$$\begin{matrix}= ( {\sum }_{k} {δ}_{p k}^{r + 1} \cdot {ω}_{{k}_{j}}^{r + 1} ) {Γ}_{r}^{′} ( Ne {t}_{pj}^{r} )\end{matrix} ;$$

5) adjusting a weight array coefficient Δωⱼᵢ^{r}=ηδₚⱼ^{r}oₚᵢ^{(r-1)} Δθⱼ^{r}=ηδₚⱼ^{r};

6) if p<P, p←p+1, turning to step 2), and otherwise, turning to step 7);

7) if E<Eₘₐₓ, ending the process, and otherwise E←0, p←1, turning to step 2).

According to the above-mentioned back propagation network algorithm, the initial error is brought into the back propagation network, and the weight array of each layer of the neural network is adjusted to correct the model.

y=110.5313+0.1464x₁−26.5709x₂−0.0001₁²+1.8475x₂²

The standard deviation is 4.5362 as calculated, and the error is acceptable, indicating the significance of the model is good. The function is stored in the neuron as a function of the neuron.

After the evaluation and cultivation assistant system accepts the obtained model, the system uses simulated annealing and the improved algorithm thereof to find the globally optimum extremum.

Because merchant B needs to know how to set prices to maximize sales, the global maximum value needs to be found.

1) Initialize: initial temperature T (high enough), lower temperature limit T min (low enough), initial solution state (x1, x2) (starting point of iteration of algorithm), iterations L of each T value;

2) perform step 3) to step 6) on 1=1,2, . . . , L1=1,2, . . . , L;

3) generate a new solution (x1,x2)_new: (x1,x2 new=x1+Δx1,x2+Δx2);

4) calculate an increment Δy=f((x1,x2)_new)−f(x1,x2), where f(x1,x2) is an optimization objective;

5) if Δy>0, accept (x1,x2)_new as a new current solution, and otherwise, accept (x1,x2)_new as a new current solution by probability of exp(−Δy/(kT));

6) if a termination condition is satisfied, output the current solution as the optimum solution, and end the process (the termination condition is usually that several continuous new solutions are not accepted, under which the algorithm is terminated);

7) T gradually decreases and T>T min, T>T min, then turn to step 2).

According to the above-mentioned algorithm, the following is obtained:

when the related expense level X₁ is 732 RMB and the live webcast charge price X₂ is 7.1910 RMB, the output function obtains the maximum volume of demand, which is 68.5775.

As the live webcast facing people selected by XXX is the teenagers, the system automatically grabs the Internet data and obtains that in the area selected by XXX, the related expense level of such people is 839 RMB which can completely cover the extremum point.

Therefore, the system will prompt XXX as follow:

“Hello, according to your choice, we calculate that, when your live webcast charge is priced at 7.19 RMB, the number of fans can reach a maximum of 680,000. In case of situations such as change in expense and competition, we need to recalculate accordingly.”

The evaluation and cultivation assistant system stores the model and extremum as data in the intelligent storage unit. According to a certain period of time, the system actively grabs data in the system and other Internet systems, and retrains, learns and updates the model. Within an appropriate period, the artist XXX is prompted about the change in the model and extremum and XXX is suggested to make an adjustment. At the same time, in the case of authorization, when other artists need similar analysis, a reference can be provided.

### Embodiment 3

Customer C has trained an artist KKK, whose remuneration is 1.3 million RMB/year.

For a certain reason, customer C needs to transfer the artist.

Customer C tells the system: “I want to transfer the cultivation right of KKK.”

Similar to Embodiment 1 and Embodiment 2, the system uses the voice recognition function in information collection to analyze the intention of customer C and reply to customer C as follow:

“Hello, the system has received your request. In order to determine a reasonable transfer price, please answer the following questions:

Age of artist? Answer: 21 years old

Gender of artist? Answer: male

Education background? Answer: bachelor degree

Height: 179 cm

Weight: 62 kg

Talent and specialty? Answer: piano and pop songs

Marital status: single

What popular elements does he have? Answer: lyric

What is the family background? Answer: normal family, not single parent.

What is the price range of target signing? Answer: 1.5-2 million RMB/year

What is the current number of fans? Answer: 2 million

Negative news? Answer: no

The most popular media? Answer: Internet, TV and radio.

Professional training experience: vocal music, piano

Do you accept the transfer of other brokers? Answer: yes

How many years have you been cultivating the artist? Answer: 1 year

Comprehensive score of cultivation and evaluation: 82%

After answering the questions, customer C will submit. The system takes the choices of customer C as inputs, uses an approximate selection function in the neural network to screen data, and takes the result of selection as an output.

As screened by the neural network, according to the above-mentioned constraints, the most recent similar transaction records are as follows:

| | | | | | | Education | Evaluation | Number | Original | Transaction |
|---|---|---|---|---|---|---|---|---|---|---|
| Number | Artist | Broker | Gender | Age | Specialty | background | score | of fans | price | price |
| 1 | SSS | DZ | Male | 21 | Vocal | Associate | 79% | 1.5 | 1.08 | 1.05 |
| | | | | | music | degree | | million | million | million |
| 2 | FFF | KL | Male | 22 | Violin | Associate | 81% | 2.5 | 1.5 | 1.48 |
| | | | | | | degree | | million | million | million |
| 3 | PPP | CE | Male | 19 | Piano | Bachelor | 80% | 1.85 | 1.27 | 1.26 |
| | | | | | | degree | | million | million | million |

The artificial neural network system uses the relevant function of the analysis and comparison module to automatically identify that the artist KKK of customer C is better than the artist PPP in record 3. Therefore, the price should be more than 1.26 million RMB. The system averages the three similar record prices and performs fine adjustment, and obtains the transfer price recommended to customer C which is 1.35 million RMB. The system tells customer C as follow:

“Hello, after a systematic comparison, the recent similar transaction records are as follows:

| | | | | | | Education | Evaluation | Number | Original | Transaction |
|---|---|---|---|---|---|---|---|---|---|---|
| Number | Artist | Broker | Gender | Age | Specialty | background | score | of fans | price | price |
| 1 | SSS | DZ | Male | 21 | Vocal | Associate | 79% | 1.5 | 1.08 | 1.05 |
| | | | | | music | degree | | million | million | million |
| 2 | FFF | KL | Male | 22 | Violin | Associate | 81% | 2.5 | 1.5 | 1.48 |
| | | | | | | degree | | million | million | million |
| 3 | PPP | CE | Male | 19 | Piano | Bachelor | 80% | 1.85 | 1.27 | 1.26 |
| | | | | | | degree | | million | million | million |

The transfer price recommended to you is 1.35 million RMB. Thanks!”

Customer C accepts the recommended price given by the system. The system automatically uploads the artist information and release the product according to the transfer process of artist cultivation rights.

After release, the system uses the neural network to start an automatic search function by using the artist condition of the customer as an input, so as to search for purchase demands of other customers for such artists or artists satisfying similar conditions, and takes customers intended to purchase the artist or similar artists as an output. When allowed, the system uses the display module to push information to customers interested in the artist or similar artists.

The people to whom the system pushes the information include customer D. Customer D recently wants to cultivate artists and has searched for similar information.

Customer D receives transfer information about customer C through mobile phone, views it, and informs customer C of its intention to receive the artist of customer C. After receiving the information from customer D, customer C communicates with customer D using a instant messaging system of the system. The system uses the instant messaging system to complete communication and stores the communication information in the intelligent storage module.

After communication, customer C and customer D reach consensus on the following intention:

Customer D confirms to receive the brokering right of KKK from customer C at the cost of 1.35 million RMB.

According to the system policy, both sides of the transaction respectively get TTT reward points issued by the system, and customer C gets 1.35 million reward points, and customer D gets 1.35 million reward points.

In the above-mentioned transaction process, the system retrieves that the TTT reward point issuing organization is the evaluation system and submits the block chain record demand to the system. Then, the evaluation and cultivation assistant system and its branches, as the nodes of the block chain, automatically carry out the block chain recording work. The specific process is as follow:

The evaluation system needs to disclose data related to reward points such as reward point issuance and exchange by using the block chain technology. The evaluation and cultivation system takes the reward points issued by itself as the bookkeeping reward of the block chain network node.

The work flow of the block chain mainly includes the following steps: the service system contacts the block chain network nodes, informs the data recording demand and reward conditions of the evaluation and cultivation system, and can also be used as one of the network nodes. After receiving the reward demand of the evaluation and cultivation system, the block chain node confirms with the evaluation and cultivation assistant system and becomes a candidate node. The service system, as the transmitting node, broadcasts data records of organization E and organization F, applying the block chain service, to the candidate block node on the entire network, and the data as a whole is strictly encrypted; the receiving node decrypts the received data by using a consensus algorithm and performs recorded information verification to verify whether the information complies with a requirement on consensus within an integral block, and data records are brought into a block after verification passes; all receiving nodes on the entire network execute the consensus algorithm (proof of workload, proof of rights and interests, etc.) on blocks, and workload or rights and interests are paid through reward points, legal tender and the like; and the blocks are formally brought into a block chain for storage after passing the consensus algorithm process, candidate nodes of the entire network express to accept this block, and the method of expressing acceptance is to regard the random hash value of the block as the latest block hash value, and the manufacture of the new blocks will be extended on the basis of the block chain. In this way, the data records of all organizations applying the block chain technology in the service system are disclosed and unalterable, and are recorded publicly by a plurality of nodes in the block, such that the core data and records of the evaluation and cultivation system are open and transparent so as to increase the credit of the evaluation and cultivation system. In addition, the exchange between the reward points of customer C and the reward points of customer D is supported. According to an exchange signal provided by the third party exchange platform, the reward points of customer C can be increased or decreased. Similarly, the system can also increase or decrease the reward points of customer D.

The evaluation and cultivation assistant system provides a unified public block chain technology for all organizations applying the system, including service architecture such as public block chain, alliance block chain and private block chain. Any organization requiring block chain service can apply the block chain technology service provided by the service system. The organizations that need to apply the block chain need to perform related preparation work such as technology adjustment and incentive policy confirmation according to the requirements of the service system, such that they can provide accessibility of their own data in service and transaction to the block chain system, so as to achieve open, transparent and unalterable data book.

Specific examples are used to illustrate the inventive concept in detail herein. The description of the above-mentioned embodiments is only used to help understand the core ideas of the present invention. It should be pointed out that any obvious modification, equivalent replacement or other improvement made by a person skilled in the art without departing from the concept of the present invention shall be included in the protective scope of the present invention.

What is claimed is:

1. An artist comprehensive ability evaluation and cultivation assistant system based on artificial intelligence, comprising:
an artificial intelligence unit configured to:
construct an artificial intelligence model according to an artificial neural network model and acquired data related to artist comprehensive ability evaluation and cultivation suggestions; and
provide, according to the artificial intelligence model, a user having a demand for artist comprehensive ability evaluation and cultivation suggestions with one or more of: artist comprehensive ability reward point values, cultivation suggestions, prediction of situations and matching of information.

2. The system of claim 1, wherein the artificial intelligence unit comprises an information collection and sensing module, a computing module and an intelligent storage module, and the constructing the artificial intelligence model according to the artificial neural network model and acquired data related to artist comprehensive ability evaluation and cultivation suggestions comprises:
using the information collection and sensing module to collect data;
selecting core-related indexes of data related to evaluation and suggestions as input neuron nodes;
calling the computing module to form a neural network model; and
inputting collected historical data into the neural network model to train the artificial intelligence model according to a predetermined algorithm.

3. The system of claim 2, wherein the constructing the artificial intelligence model according to the artificial neural network model and acquired data related to artist comprehensive ability evaluation and cultivation suggestions further comprises:
configuring the core-related indexes into related variables in a computer, wherein each of the related variables having a specific address and logic storage space in the intelligent storage module.

4. The system of claim 2, wherein the calling the computing module to form the neural network model comprises:
adding weights for mutual influences among input variable nodes, hidden variable nodes and output variable nodes, to evaluate and quantify influences on other related variables when one or more of the related variables change.

5. The system of claim 2, wherein inputting collected historical data into the neural network model to train the artificial intelligence model according to the predetermined algorithm comprises:
inputting historical data and sorting the related variables, the weights and result data according to a logic sequence, wherein the result data comprising at least one of: an artist comprehensive ability evaluation score node, a social literature and art preference development prediction node, an economic benefit analysis of artist cultivation node, an artist cultivation suggestion node, automatic rapid matching of fans group node, a risk evaluation and system operation efficiency and security prompt node;
operating, by the computer, to find and determine a model function relationship suitable for the related variables by using the result data as a function, the neural network, a regression mathematical model training method; determining, by the computer, an optimum function relationship by comparing fitting degrees between different function images and scatter diagrams, and storing the optimum function relationship in the intelligent storage unit; and
using, during training the artificial intelligence model, a back propagation network algorithm to return errors to each layer and node of the neural network while obtaining model output, wherein each node corrects a weight and then reacquires an input parameter to perform model verification till the errors decrease to a preset range; updating the data in corresponding storage spaces after obtaining effective weights and function relationships of nodes at each layer.

6. The system of claim 5, wherein the computing module further comprises a judgment and decision-making module, and when a decision needs to be made according to a reliable model after model verification, the judgment and decision-making module performs iterative verification on the optimum judgment of a system by adopting a simulated annealing algorithm, to guarantee that the decision-making is globally optimum.

7. The system of claim 2, wherein the computing module comprises at least one of a system learning and optimization module, an innovation and prediction module, an analysis, comparison and operation module and the judgment and decision-making module, wherein:
the system learning and optimization module is configured to execute a self-learning process by using the back propagation algorithm;
the innovation and prediction module is configured to perform innovative trying and development prediction on things by using an artificial intelligence algorithm based on current data and information;
the analysis, comparison and operation module is configured to perform analysis, comparison and operation by adopting a proper method based on collected data after a target is clearly known, so that a decision-making and expression module outputs results; and
the judgment and decision-making module is configured to perform iterative verification on the optimum judgment of the system by adopting the simulated annealing algorithm, to guarantee that the decision-making is globally optimum.

8. The system of claim 1, further comprising a reward point management subsystem configured to execute the following steps:
receiving an operation instruction of a customer to reward points, the operation instruction containing an indicator, the indicator being used for indicting information of corresponding reward points stored in a network node device; searching reward point data matching a customer behavior according to the indicator; and
confirming an operation behavior of the customer to the reward points according to matched data stored in an organization, adjusting reward point quantity information of the customer after confirmation, and forming an operation.

9. The system of claim 8, wherein the reward point management subsystem is configured to further execute at least one of:
a reward point issuance and consumption operation, in which, when the customer consumes and evaluates an artist, the system uses a reward point system to give a score to the artist, and after evaluation is completed, the evaluation and cultivation assistant system instructs to increase corresponding reward points in a customer logic storage unit; and when the customer uses the reward points to exchange one or more of corresponding rights, services and real objects, the system instructs to decrease the corresponding reward points in the customer logic storage unit;
an artificial intelligence prompt operation, configured to manage a price of the reward points and prompt a customer about a price change trend of the reward points according to personal risk and benefit preference information; and
a reward point transfer operation, in which, when any reward point of an access customer changes, the evaluation and cultivation assistant system needs to confirm that a transferee of assets or reward points has an account of such reward points, and decreases reward points of a transferor, increases reward points of the transferee, and saves relevant records, by interacting information with a third party or a reward point transaction platform.

10. The system of claim 1, further comprising a block chain module, wherein the block chain module uses the evaluation and cultivation assistant system as a transmitting node and broadcasts a new data record block node of an organization applying a block chain service on the entire network; a receiving node decrypts the received data by using a consensus algorithm and performs recorded information verification to verify whether the information complies with a requirement on consensus within an integral block, and data records are brought into a block after verification; all receiving nodes on the entire network execute the consensus algorithm on blocks; and the blocks are formally brought into a block chain for storage after passing the consensus algorithm process.

11. The system of claim 2, wherein the core-related indexes of data related to evaluation and suggestions comprise one or more of: economic operation, scientific development, field of artists, and characteristics of artists.

12. The system of claim 5, wherein the regression mathematical model training method is one of a linear regression mathematical model training method and a nonlinear regression mathematical model training method.
